(19) United States
(12) Patent Application Publication
(10) Pub. No.: US 2014/0246837 A1
(43) Pub. Date: Sep. 4, 2014

(54) HAND TRUCK FOR STORING AND MOVNG MULTIPLE STORAGE BINS

(71) Applicants: Thomas Delattre, Stuart, FL (US); David Carson, Stuart, FL (US)

(72) Inventors: Thomas Delattre, Stuart, FL (US); David Carson, Stuart, FL (US)

(21) Appl. No.: 14/194,397

(22) Filed: Feb. 28, 2014

Related U.S. Application Data
(60) Provisional application No. 61/770,878, filed on Feb. 28, 2013.

(51) Int. Cl. B62B 1/14

(52) U.S. Cl. CPC B62B 1/14
USPC 280/47.19

(57) ABSTRACT

The present invention relates to an improved hand truck configured to hold multiple storage bins, such as recycle bins. The hand truck comprises a main body structure having a generally elongated, upper vertical first frame, a generally horizontal lower horizontal frame, and pair of wheels 16. A plurality of storage bin supports are utilized to suspend at least two storage bins, preferably recycle bins, in a parallel manner relative to each other. Each of the bins can be stored in suspended position, off the ground.

### PRIORITY CLAIM

In accordance with 37 C.F.R. 1.76, a claim of priority is included in an Application Data Sheet filed concurrently herewith. Accordingly, the present invention claims priority to U.S. Provisional Patent Application No. 61/770,878, entitled “HAND TRUCK FOR STORING AND MOVING MULTIPLE STORAGE BINS”, filed Feb. 28, 2013. The contents of which the above referenced application is incorporated herein by reference in its entirety.

### FIELD OF THE INVENTION

The present invention relates to a device for storing and moving containers; and more particularly to a hand truck configured to store and move recycle bins.

### BACKGROUND OF THE INVENTION

Hand trucks, or dollies, are common devices used for moving heavy objects such as furniture or appliances, over a relatively short distance. Such devices are vital for delivery personnel who use the hand truck to delivery cargo from a delivery truck to the cargo's ultimate destination. Because these devices are vital tools for moving objects, various types of hand trucks are known in the art. For example, U.S. Pat. No. 4,728,245 teaches an improved power assisted hand truck described as including a lower frame and an upper, upwardly extending, tilting frame for supporting a load in a generally upright and rearward tilting orientations. The upper frame is described as being tilted forward by a first hydraulic actuator mounted between the lower and upper frame portions. To stabilize the hand truck while raising the load, a stabilizer, pivotally mounted to the frame, is driven by a second hydraulic actuator mounted between the frame and the stabilizer. The first and second actuators are described as being powered by a hand pump.

U.S. Pat. No. 5,716,183 teaches a hand truck for moving objects from one location to another. The hand truck is described as including a frame extending longitudinally from a foot end to a handle end, the frame including a first elongated member, a second elongated member spaced from the first elongated member, and a cross member extending between and fixed to the first and second elongated members. The hand truck also includes at least one ground engaging wheel rotatably mounted to the frame for rotation about a wheel axis adjacent the foot end thereof. A first arm is described as slidingly connected to the first elongated member, wherein the first arm extends substantially perpendicular to the first elongated member, and a second arm slidingly connected to the second elongated member, wherein the second arm extends substantially perpendicular to the second elongated member as provided, as is a brace member slidingly connected to the frame. The first arm, the second arm, and the brace member are fixed at desired locations along the frame between the foot end and the head end. The first and second arms include a cross member extending between and connected thereto, to position the first and second arms in substantially parallel relation.

U.S. Pat. No. 6,173,811 teaches a hand truck, stepladder and basket carrier combination. The device is described as a portable and collapsible unit that converts into a hand truck having two wheels, a stepladder having the wheels raised and locked into place, and a basket carrier attached to the hand truck. The basket is collapsed into the hand truck frame when not in use.

U.S. Pat. No. 6,364,328 teaches a hand truck described as being convertible into either one of a cart and an inclined cart which includes a primary frame having a first pair of wheels rotatably mounted thereon. A secondary frame is pivotally attached to the primary frame and has at least one additional wheel rotatably mounted thereon. A connecting member is attached to the secondary frame. A first locking mechanism is attached to the primary frame and detachably secures the secondary frame to the primary frame while the secondary frame is in the hand-truck-position and while the secondary frame is in the inclined-cart-position. A second locking mechanism is attached to the primary frame and detachably secures the connecting member to the primary frame while the secondary frame is in the inclined-cart-position. Alternatively, a channel is formed in the primary frame and the connecting member is slidably engaged with the channel.

U.S. Patent Application Number 2012/0286483 teaches a hand truck with a lifting mechanism. The device is described as having a frame having a handle portion, and a load-carrying portion. An axle is supported by the frame and has wheels rotatably mounted to opposed ends of the axle. An extendible member is pivotally mounted to the axle. The extendible member comprises a housing and an extendible portion that extends from the housing. The extendible portion has an engagement end, the engagement end retracting within an outer perimeter of the wheels in a retracted position, and extending outward to engage a ground surface. In the extended position, the extendible member has a length that is greater than a diameter of the wheels. A control mechanism selectively extends and retracts the extendible portion.

While most of the above listed references describe hand trucks which can carry multiple objects, a shortcoming of the cited references are their inability of carrying objects aligned in a parallel and stacked orientation. Such alignment allows for the hand truck to carry loads having objects which are not uniform. The present invention is designed for such tasks. Over the past decade, society has embraced the green movement which attempts to minimize damage to the earth by creating eco-friendly products and reusing existing materials whenever possible. One part of the green movement is the desire to recycle materials. These materials are separated from standard garbage bins so that the materials can be processed at a different plant. Separation begins with the user separating the materials, such as bottles and plastics into separate containers, such as a “blue recycle bin” for glass and plastics and a “yellow recycle bin” for paper materials. These bins are placed in an area to be picked up by recycle companies in a similar manner as typical garbage pick-up. While the storage bins can be placed onto a standard hand truck, the contents of the storage bin are irregular in shape making it difficult to safely and securely stack multiple bins. During movement of the bins therefore, the user is at increased risk of one of the recycle bins falling and spilling its contents.

Therefore, what is needed in the art is a hand truck configured to move multiple storage bins, such as recycle bins, in an easy and efficient manner.

### SUMMARY OF THE INVENTION

The present invention relates to an improved hand truck configured to hold and move multiple storage bins, such as recycle bins. The hand truck comprises a main body structure having a generally elongated, upper vertical first frame, a generally horizontal lower horizontal frame, and a pair of wheels. While the lower horizontal frame can be a load bearing surface, the hand truck in accordance with the present invention is constructed and arranged to support storage bins in a different manner. A plurality of storage bin support clips is utilized to suspend at least two storage bins in a parallel and stacked orientation relative to each other. Each of the bins can be stored in a suspended position, off the ground and at a distance from the lower horizontal frame.

Accordingly, it is an objective of the instant invention to provide a device for supporting and carrying objects.

It is a further objective of the instant invention to provide for an improved hand truck.

It is yet another objective of the instant invention to provide a hand truck configured for supporting and moving multiple storage devices.

It is a still further objective of the invention to provide a hand truck configured for supporting and moving multiple recycle bins attached thereto.

It is a further objective of the instant invention to provide a hand truck configured for supporting and moving multiple recycle bins attached thereto in a parallel orientation.

It is a still further objective of the invention to provide a hand truck configured for supporting and moving multiple recycle bins attached thereto in a stacked orientation.

It is yet another objective of the instant invention to provide a hand truck configured for supporting and moving multiple recycle bins attached thereto in a suspended orientation.

Other objectives and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a perspective view of an illustrative example of the hand truck configured to hold and move a container;

FIG. 2 is a side view of the hand truck configured to hold and move a container;

FIG. 3A is a front view of the hand truck configured to hold and move a container;

FIG. 3B is a cross sectional view taken along lines 3A-3A in FIG. 3A;

FIG. 4 is a front view of the hand truck with recycle bins attached thereto;

FIG. 5A is a side view of the hand truck with recycle bins attached thereto;

FIG. 5B is a cross sectional view taken along lines 5A-5A in FIG. 5A;

FIG. 5C is a blow up view of lines 5-5 shown in FIG. 5B;

FIG. 6A is an exploded view of the hand truck configured to hold and move a container;

FIG. 6B is a partial exploded side view of the hand truck configured to hold and move a container;

FIG. 7 is a perspective view of an illustrative example of an upper bar of the upper vertical first frame;

FIG. 8 is a top view of the upper bar illustrated in FIG. 7;

FIG. 9 is a side view of the upper bar illustrated in FIG. 7;

FIG. 10 is a perspective view of an illustrative embodiment of a vertical rod of the upper vertical first frame;

FIG. 11 is a perspective view of the horizontal frame;

FIG. 12 is a top view of the horizontal frame;

FIG. 13 is a bottom view of the horizontal frame;

FIG. 14 is a side view of the horizontal frame;

FIG. 15 is a perspective view of an illustrative example of a sleeve member;

FIG. 16 is a front view of an illustrative wheel;

FIG. 17 is a perspective view of an illustrative example of an axle;

FIG. 18 is a blow up view of lines 17-17 shown in FIG. 17;

FIG. 19 is an illustrate example of a cross bar;

FIG. 20 is a perspective view of an illustrative example of a support clip;

FIG. 21 is a top view of the support clip; and

FIG. 22 is a side view of the view of the support clip.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

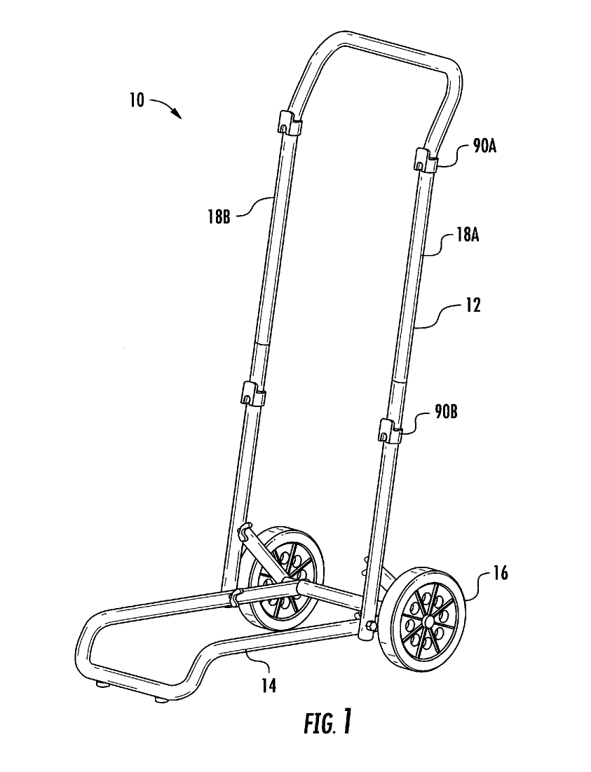

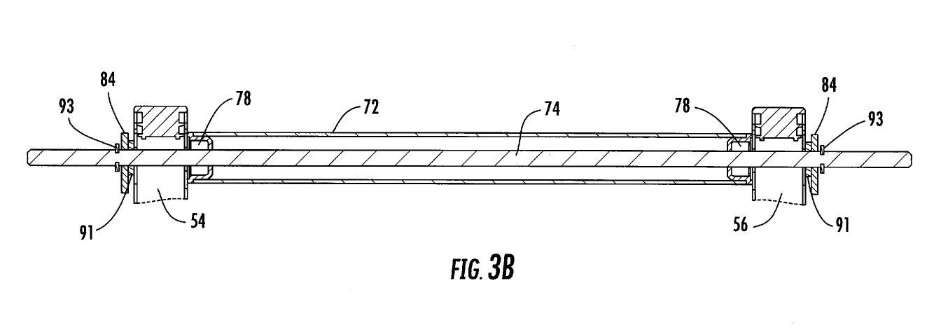

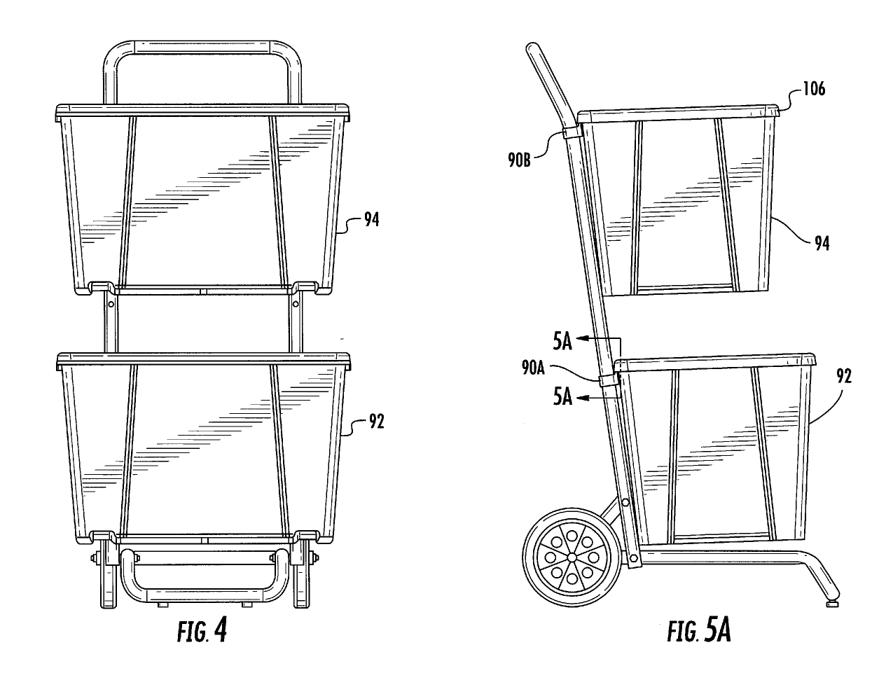

Referring to FIGS. 1-3A, a movable hand truck configured to hold and move a container, referred to generally as 10, is illustrated. The movable hand truck configured to hold and move a container 10 is preferably configured to secure thereto and move two or more containers, illustrated herein as recycle bins 92 and 94, see FIGS. 4 and 5. While one or more recycle bins are the preferred container, use of recycle bins are illustrative only and are not intended to be limiting. The movable hand truck is configured to hold and move multiple containers 10 comprises a main body structure having a generally elongated, upper vertical first frame 12, a generally horizontal frame 14, and a pair of wheels 16. The vertical first frame 12 is mounted to the horizontal lower horizontal frame 14, preferably at a distance from where the horizontal lower horizontal frame 14 mounts to the pair of wheels 16 via an axel assembly (to be described later).

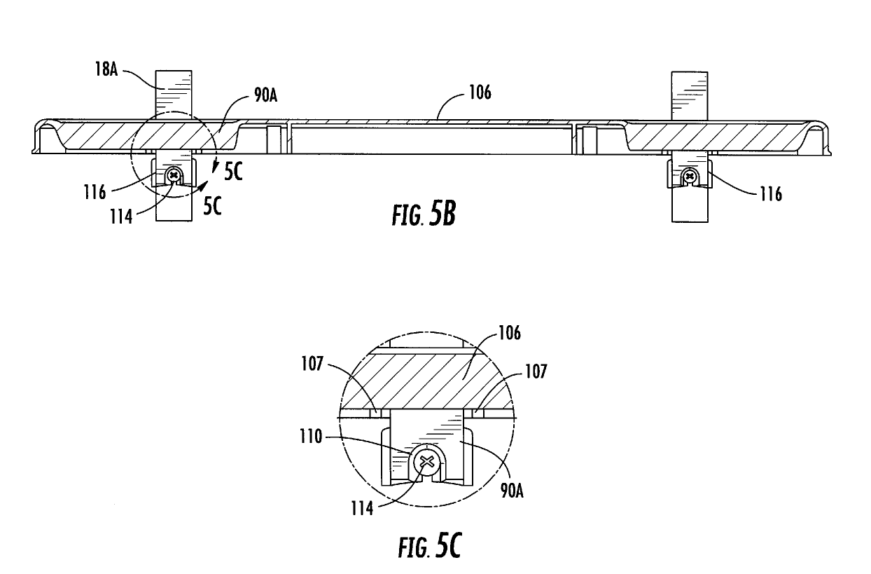

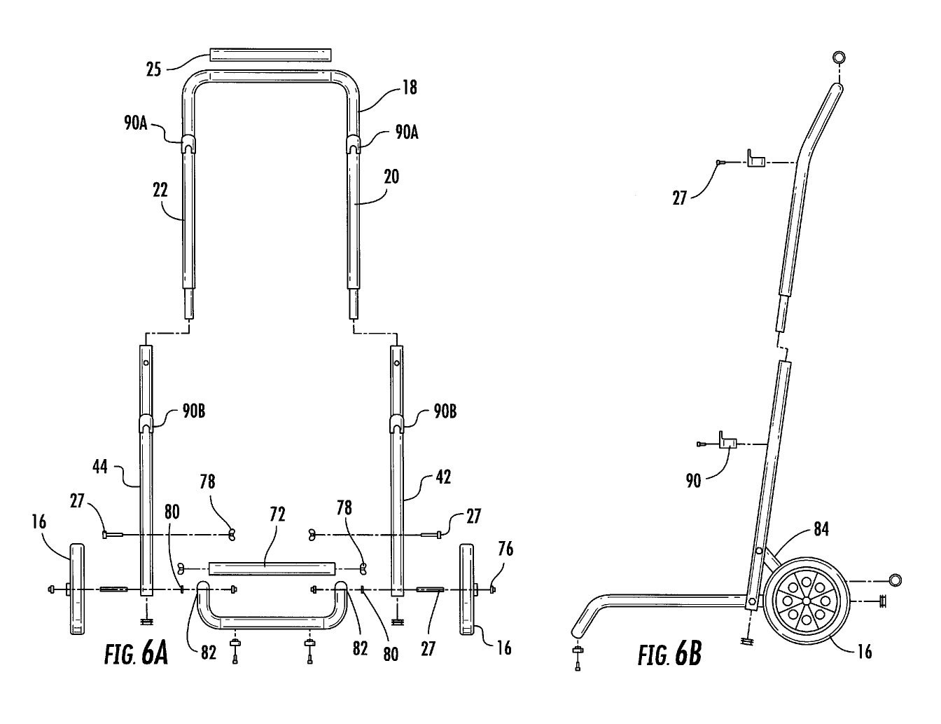

The vertical first frame 12 comprises a pair of vertical members 18A and 18B comprising a plurality of elongated vertical upper rod members 20 and 22, see FIGS. 6A-9. The elongated upper rod members 20 and 22 are arranged in a generally parallel, spaced apart manner and interconnected by a generally U-shaped bar 24 which forms a handle. The U-shaped bar 24 comprises two vertical handle members 26 and 28 connected by a base member 30. The U-shaped bar 24 forms a handle, thereby allowing a user the ability to manipulate and move the hand truck configured to hold and move multiple containers 10. To aid the user, the U-shaped bar 24 may contain a foam grip 25. The vertical members 18A and 18B may be formed as a single unitary piece or may be formed by securing the generally U-shaped bar 24 to the elongated rod members 20 and 22 using securing mechanisms such as welding or securing members such as screws as known to one of skill in the art. In an illustrative embodiment, elbows 32 and 34 may be used to connect the two vertical handle members 26 and 28 of the U-shaped bar 24 to the elongated rods 20 and 22 to form an angle α relative to a vertical frame member longitudinal axis 36, see FIG. 9. In a preferred embodiment, the angle α is between 10 and 30 degrees, and more preferably at or near 20 degrees.

The bottom ends 38 and 40 of the two vertical handle members 26 and 28 secure to two vertical lower rod members 42 and 44, see FIG. 6A, using a securing member such as a screw 27, preferably a sheet metal screw. FIGS. 6A and 10 show an illustrative embodiment of the vertical rod member 42. The vertical rod member 44 is identical to the lower rod member 42, thus having the same features. Accordingly, while only the vertical lower rod member 42 is illustrated and described, each feature applies equally to the vertical lower rod member 44 as well. As shown in FIG. 10, the vertical lower rod member 42 contains a generally cylindrically shaped body 46 having a first end 48 and a second opposing end 50. To secure the second opposing end 50 of the vertical rod member 42 to the bottom end of the vertical member 18A, the bottom end 38 is inserted into the opening 52 of the second opposing end 50 and secured using securing members such as screws. Alternatively, the vertical member 18A and 18B may be made of a single, unitary member.

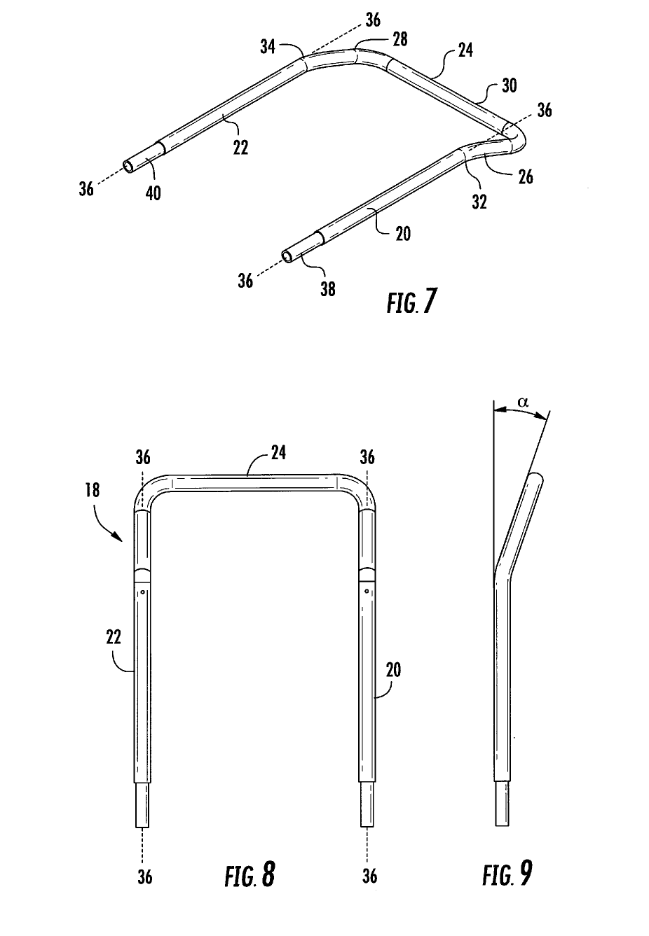

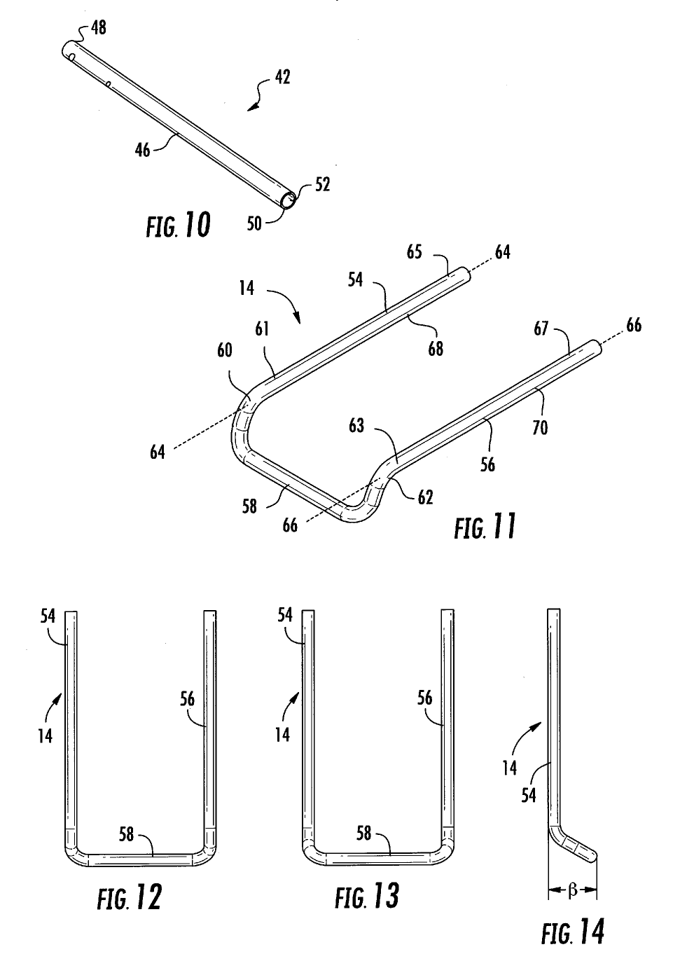

The lower horizontal frame 14 comprises two horizontal frame members 54 and 56, see FIGS. 11-14. The two horizontal frame members 54 and 56 are arranged in a generally parallel manner and separated by a connecting bar, illustrated herein as a horizontal frame U-shaped bar 58. The horizontal frame U-shaped bar 58 is positioned at a first proximal end 61 and 63 of horizontal frame members 54 and 56. Opposing second ends, or the distal ends 65 and 67 provide a position where the axle assembly mounts thereto. The horizontal frame U-shaped bar 58 may be integrally formed with the two horizontal frame members 54 and 56. Alternatively, the horizontal frame U-shaped bar 58 may be formed independently of the horizontal frame members 54 and 56 and secured together using screws to form the lower horizontal frame 14. The U-shaped bar 58 may include elbows 60 and 62 which allow the U-shaped bar 58 to extend in an inclined, downward position, i.e. toward the ground when the movable hand truck configured to hold and move a container 10 is in a resting, non-mobile position, relative to the longitudinal axis and 66 of the horizontal frame members 54 and 56, thus forming angle β. The angle may be, for example, between greater than 1 degree and 70 degrees, and preferably about 60 degrees. Although the lower frame 14 is shown attached to the one or more components of the device 10 in a fixed position, it may be configured to be pivotally attached so that the lower frame 14 can move in an upward (parallel to the first frame 12) and downward (perpendicular to the first frame 12) orientation.

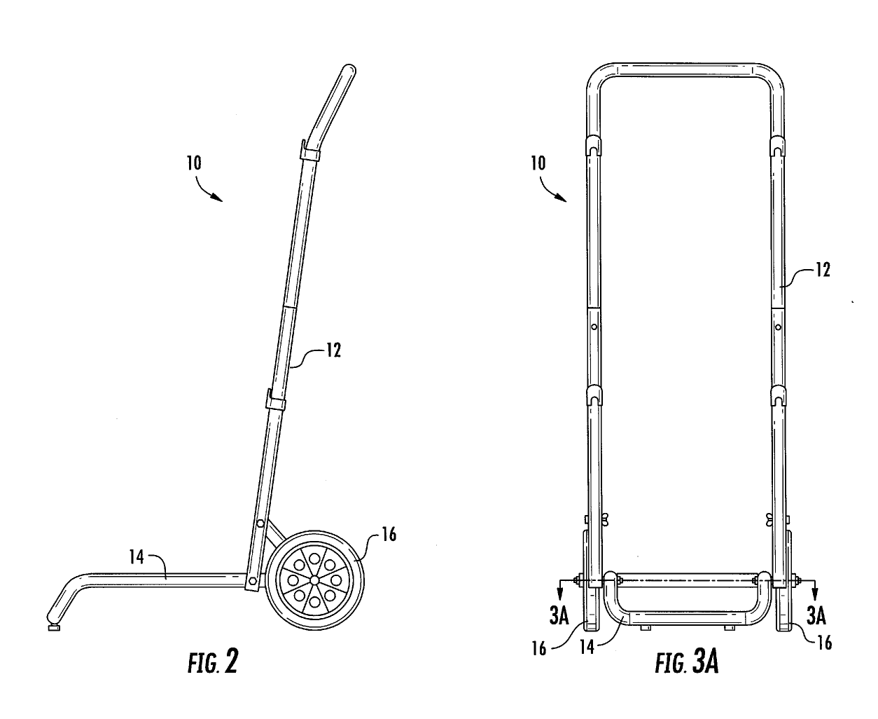

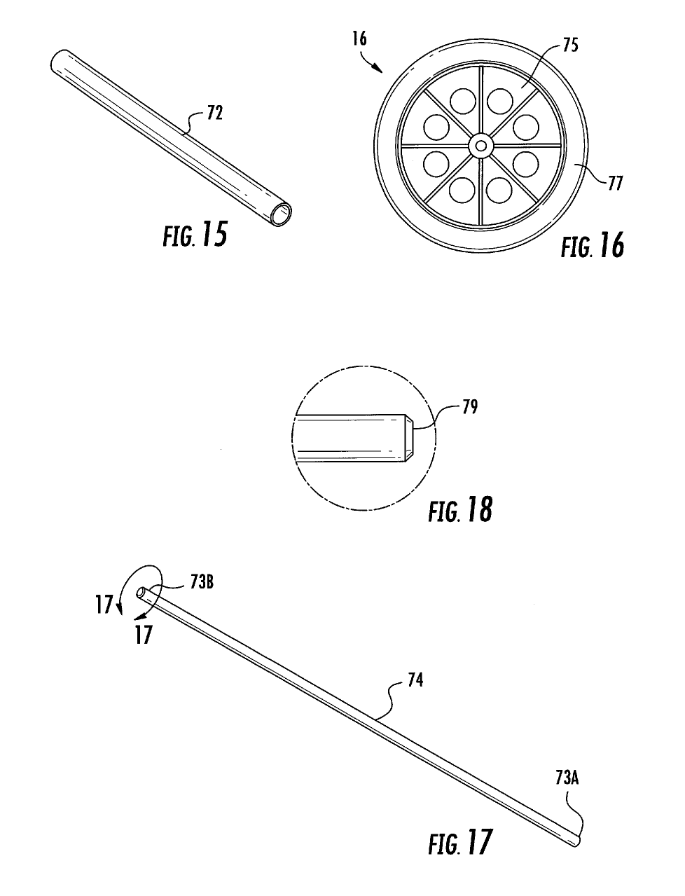

Each of the two horizontal frame members 54 and 56 contain openings 68 and 70, (FIG. 11) sized and shaped to receive securing members such as screws to secure lower horizontal frame 14 to a sleeve 72, see FIG. 15. The sleeve is preferably a hollow tubular body sized and shaped to receive an axle 74, see FIGS. 17 and 18. The axle 74 and the wheels 16 together define an axle assembly. The wheels 16 are rotatably mounted to the opposing ends 73A and 73B of the axle through screws, thereby providing movement to the movable hand truck configured to hold and move a container 10. The wheels 16 are standard wheels known to one of skill in the art and may include a hub 75 and rubber tire portion 77, see FIG. 16. The axle 74 may include tapered ends 79 (see FIG. 18) to prevent the wheels 16 from wobbling. A cap nut 76 (see FIG. 6A) seals the axle 74 to the wheel 16. The ends of the sleeve contain axle plugs 78, see also FIG. 3B. To maintain proper positioning and alignment, spacer 80 and retaining ring may be used. A crossbar 84 (see FIG. 19, FIG. 3B) contains a first end 86 which connects to the vertical rods 42 or 44 and a second end 88 for connecting to wheel 16. Openings 89 allow for securing screws to secure the crossbar 84 to other components of the device 10. The assembly may also contain a spacer 91 and an external retaining ring 93, see FIG. 3B.

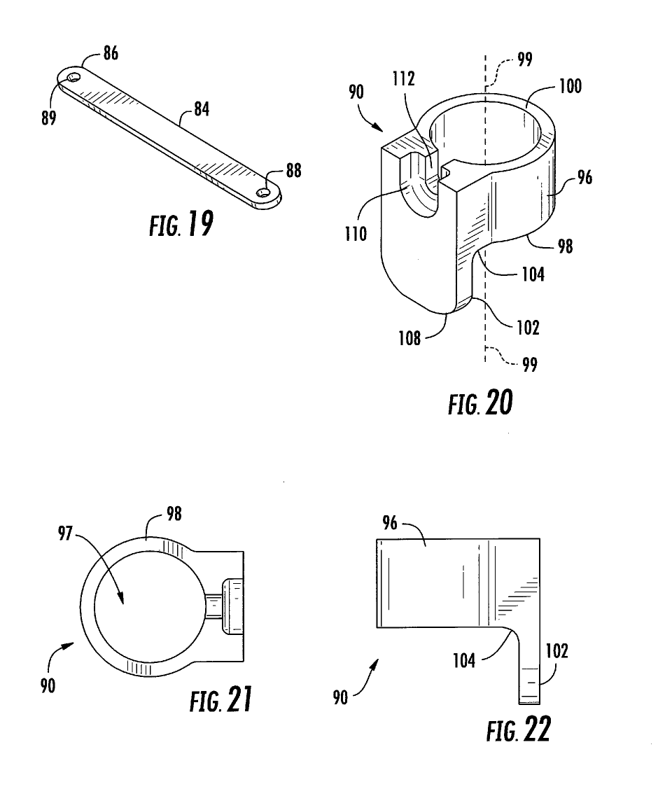

Coupled to one or more portions of the upper vertical first frame 12 is one or more support clips 90, see FIGS. 20-22. As shown in FIG. 1 and FIG. 6A, a first set of support clips 90A are coupled to the two vertical members 26 and 28 and a second set of support clips 90B are coupled to the two vertical rods 42 and 44. In this orientation, the first recycling bin 92 can be secured in a suspended position above the horizontal lower horizontal frame 14. A second recycling bin 94 can be suspended above the recycling bin 92. Placing the bins in a suspended position so that one of the recycling bins rests in a stacked position, i.e. one above the other, allows the user to safely and quickly transport the recycle bins even when one or both bins 92 and 94 are full.

Referring to FIG. 20, an illustrative example of the support clip 90 is shown. The support clip 90 is preferably made of a plastic material, but any material known to one of skill in the art, such as steel, may be used. Additives to increase strength and/or durability, such as UV stabilizers, may be included as well. The support clip 90 contains a continuous wall 96 having a generally cylindrical shape and forming an interior 97, a first top surface 98, and an opposing bottom surface 100. The shape preferably corresponds with the shape of the vertical members 18A and 18B, including vertical bars 20 and 22 and/or the two vertical rods 42 and 44. The diameter of the cylindrical shape is preferably larger than the diameter of the vertical members 18A and 18B, including vertical bars 20 and 22 and/or the two vertical rods 42 and 44 so as to provide a secure coupling when attached thereto. As such, the support clip 90 coaxially aligns with at least a portion of the vertical members 18A and 18B so that portion of support clip 90 defined by continuous wall 96 has the same longitudinal axis 99 as that of the longitudinal axis of the vertical members 18A and 18B. Extending outwardly, i.e. away from the first top surface 98, is a cantilevered, finger like appendage 102. At or near where the finger like appendage 102 extends past the first top surface 98 is a curved surface 104 which aids in securing a portion of the recycle bin, such as the lip 106 (having a tab 107), see FIGS. 5A and 5C, to the support clip 90. The curved surface 104 provides an area where the recycle bin can rest. At the opposite end of the top surface 108 of the cantilevered, finger like appendage 102 is a recessed region 110, illustrated having a u-shaped configuration which aligns with a u-shaped slotted region 112 to provide a mechanism for securing the support clip 90 to the vertical member 18A or B via a securing device such as a screw 114, see FIGS. 5B and 5C. The support clip 90 may further contain an outer edge 116 for additional support.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well configured to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A movable hand truck configured to hold and move at least one container comprising:
a vertical frame assembly comprising a pair of elongated vertical members;
a horizontal frame assembly comprising a pair of elongated horizontal members separated by a horizontal connecting member;
an axle assembly comprising an axle having a pair of wheels mounted at opposite sides of said axle, said axle separating said pair of elongated horizontal member and mounted a distal end of said elongated horizontal members;
at least one support clip configured to support a storage bin in a suspended position above said horizontal frame assembly, said support clip coaxially aligned with at least one elongated vertical member of said vertical frame assembly.

2. The movable hand truck configured to hold and move at least one container according to claim 1 further comprising a handle, said handle having a pair of vertical handle members separated base member forming a U-shaped configuration, said pair of handle members positioned at an inline angle from a longitudinal axis of said vertical frame members.

3. The movable hand truck configured to hold and move at least one container according to claim 2 wherein said angle is an acute angle.

4. The movable hand truck configured to hold and move at least one container according to claim 1 wherein said horizontal frame assembly connecting bar is a U-shaped member extending below a horizontal frame member longitudinal axis.

5. The movable hand truck configured to hold and move at least one container according to claim 4 wherein said U-shaped member extends below said horizontal frame member longitudinal axis at an acute angle.

6. The movable hand truck configured to hold and move at least one container according to claim 1 wherein each said elongated vertical member of said vertical frame assembly comprises a support clip configured to support a storage bin.

7. The movable hand truck configured to hold and move at least one container according to claim 1 wherein each said support clip comprises a top surface, a body surface, and a continuous wall therebetween separating said top and said bottom surface, said continuous wall forming an interior sized and shaped to receive at least a portion of said elongated vertical member of said vertical frame assembly.

8. The movable hand truck configured to hold and move at least one container according to claim 7 wherein said a support clip further comprises a cantilevered appendage extending above said first surface.

9. The movable hand truck configured to hold and move at least one container according to claim 8 wherein said cantilevered appendage comprises a curved surface configured to couple with a container bin resting thereupon.

10. A movable cart configured to hold and move at least two containers comprising:
a vertical frame assembly comprising a pair of elongated vertical members mounted to a position along a horizontal frame assembly at a distance from an axle assembly;
a horizontal frame assembly comprising a pair of elongated horizontal members separated by a horizontal connecting member;
an axle assembly comprising an axle having a pair of wheels mounted at opposite sides of said axle, said axle separating said pair of elongated horizontal member and mounted a distal end of said elongated horizontal members, said wheels sitting at a distance for a position where said elongated horizontal member mounts to said vertical frame assembly;
a plurality of support clips coaxially aligned with said elongated vertical members of said vertical frame assembly and configured to support at least two storage bins in a suspended position above said horizontal frame assembly, each said elongated vertical members of said vertical frame assembly having a pair of support clips.

11. The movable hand truck configured to hold and move at least one container according to claim 10 wherein said elongated vertical members of said vertical frame assembly comprise of a an upper bar and a lower bar.

12. The movable hand truck configured to hold and move at least one container according to claim 11 further comprising a handle, said handle having a pair of vertical handle members separated base member forming a U-shaped configuration, said pair of handle members positioned at an inline angle from a longitudinal axis of said vertical frame members.

13. The movable hand truck configured to hold and move at least one container according to claim 12 wherein said angle is an acute angle.

14. The movable hand truck configured to hold and move at least one container according to claim 12 wherein said horizontal frame assembly connecting bar is a U-shaped member extending below a horizontal frame member longitudinal axis.

15. The movable hand truck configured to hold and move at least one container according to claim 14 wherein said U-shaped member extends below said horizontal frame member longitudinal axis at an acute angle.

16. The movable hand truck configured to hold and move at least one container according to claim 10 wherein each said elongated vertical member of said vertical frame assembly comprises a support clip configured to support a storage bin.

17. The movable hand truck configured to hold and move at least one container according to claim 15 wherein each said a support clip comprises a top surface, a body surface, and a continuous wall therebetween separating said top and said bottom surface, said continuous wall forming an interior sized and shaped to receive at least a portion of said elongated vertical member of said vertical frame assembly.

18. The movable hand truck configured to hold and move at least one container according to claim 17 wherein said a support clip further comprises a cantilevered appendage extending above said first surface.

19. The movable hand truck configured to hold and move at least one container according to claim 18 wherein said a cantilevered appendage comprises a curved surface configured to couple with a container bin resting thereupon.
